(19) United States
(12) Patent Application Publication
(10) Pub. No.: US 2026/0285686 A1
(43) Pub. Date: Sep. 24, 2026

(54) PROCESS FOR MAKING CARBON NANOTUBES WITH ORIENTED FULLERENE CRYSTALS

(71) Applicant: Government of the United States as represented by the Secretary of the Air Force, Wright-Patterson AFB, OH (US)

(72) Inventors: John Bulmer, Dayton, OH (US); Charles Ebbing, Lewisburg, OH (US); Timothy Haugan, Dayton, OH (US)

(21) Appl. No.: 19/675,938

(22) Filed: May 13, 2026

Related U.S. Application Data
(63) Continuation-in-part of application No. 18/537,136, filed on Dec. 12, 2023.
(60) Provisional application No. 63/437,866, filed on Jan. 9, 2023.
(60) Provisional application No. 63/461,440, filed on Apr. 24, 2023.
(60) Provisional application No. 63/601,328, filed on Nov. 21, 2023.

(51) Int. Cl. C01B 32/178; C01B 32/152

(52) U.S. Cl. CPC C01B 32/178; C01B 32/152; C01B 2202/08; C01P 2002/70; C01P 2006/40

(57) ABSTRACT

A method of making hybrid carbon nanotube bundles. The method uses a pH neutral solvent bath followed by drying. This PH neutral solvent avoids the use of acids, superacids and caustics. The solvent preferably has a Hamett acidity function greater ranging from −12. The solvent may be aromatic hydrocarbons or halogenated solvents. The solvent preferably has a Hansen solubility parameter of 2 to 10, minimizing damage to common fullerene crystals. Embedding the fullerene crystals in the nanotubes provides improved electrical and optical properties. The presence of these fullerene crystals can modify the motion of electrons, turning standard nanotubes into components for nanoscale transistors, rectifiers, and memory devices.

### CROSS REFERENCE TO RELATED APPLICATIONS

This application is a continuation-in-part of, claims priority to and the benefit of pending application Ser. No. 18/537,136, published as US 2024/0228290 (Attorney Docket AFD2349) filed Dec. 12, 2023, which claims the benefit of provisional application 63/601,328 filed Nov. 21, 2023, and provisional application 63/461,440, filed Apr. 24, 2023, and provisional application 63/437,866 filed Jan. 9, 2023, the disclosures of which are incorporated herein by reference.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a method of embedding fullerene crystals into carbon nanotube fibers, particularly to such a method without the use of acid or superacid.

### BACKGROUND OF THE INVENTION

A fullerene is a spherical, or approximately spherical, carbon allotrope whose molecule is a closed cage composed of atoms of carbon connected by single or double bonds, For example, C60 (CAS Number 99685-96-8), C61 to C70 and C 76 fullerene crystals have been found to be of interest for the present invention. The first fullerene was discovered in September 1985 at Rice University, Huston, Texas. Fullerene C60 was named “Molecule of the Year” by the journal Science in 1991. Sir Harold W. Kroto, Robert F. Curl, Jr., and Richard Smalley were awarded the Nobel Prize in Chemistry in 1996 for the discovery of C60 fullerene crystals.

Fullerene molecules typically assemble into supramolecular crystals from van der Waals forces; various crystal structures are possible, such as face centered cubic (FCC), that depend on processing conditions. Doping these fullerene supramolecular crystals with chemical species, prototypically alkali metals, results in charge transfer to the fullerenes that greatly increase electrical conductivity and makes superconductivity possible. Films of K3C60 are well known superconductors with a critical temperature of approximately 18 K. Fullerenes can be functionalized with other chemical species to change their properties, such as the ability to dissolve in various solvents. Chemical bonding between fullerenes creates carbon bonded networks between the fullerenes that can be disordered or exist with 1D, 2D, or 3D ordering. Fullerenes can have molecules and atoms trapped within a carbon cage called endohedral fullerenes. Fullerenes which exist within each other concentrically and are called nano-onions.

Higher order fullerenes include carbon nanotubes (CNTs) that can be described as fullerenes that have been stretched along a rotational axis to form a tube. Carbon nanotubes were discovered in 1991 by Sumio lijima. Single walled carbon nanotubes (SWNTs) are by definition fullerene materials. The structure consists of a graphene sheet rolled into a tube and optionally capped by half a fullerene. The carbon atoms in a SWNT, like those in a fullerene, are hybridized. Different types of SWNTs are defined by their diameter and chirality.

Single-walled carbon nanotubes (SWCNTs) have diameters of approximately 0.5-2.0 nanometers (nm). Multi-walled carbon nanotubes (MWCNTs) consist of single-wall carbon nanotubes nested together to form a tube-in-tube structure. Double- and triple-walled carbon nanotubes are variants of MWCNT. CNTs can have different twists in molecular structure and referred to as chirality, or helicity. The twists determine the metallic or semi-conducting electronic nature of the CNT. The diameter of the CNT predominantly determines the bandgap of the semi-conducting CNT or the bandgap of additional sub-bands in a metallic CNT. CNT fibers offer lightweight, high-strength, and highly conductive alternatives to traditional materials like copper and aluminum.

Aggregation/roping of nanotubes occurs as a result of the high van der Waals binding energy of ca. 500 eV per mm of tube contact. The van der Waals force between the tubes is so great, that it is difficult make a combination of nanotubes with other materials such as in composite applications. The functionalization of nanotubes, i.e., the attachment of “chemical functional groups” provides the path to overcome these barriers. Functionalization can improve solubility as well as processibility, and has been used to align the properties of nanotubes to those of other materials.

Self-supporting and macroscale ropes, ribbons, yarn, wire, and fibers composed of CNTs offer lightweight, high-strength, and highly conductive alternatives to traditional materials such as copper and aluminum and conventional carbon fiber. The best electrical and mechanical properties of macroscale CNT materials occur when the CNTs are few-walled or single-walled, have highly aligned and densified micro-structure, and the CNT length (or aspect ratio as the CNT length/CNT diameter) is as high as reasonably possible, and preferably greater than 5600. Further, the CNT materials may be doped by a foreign species which donates charge carriers to the CNTs and aids in the transmission between CNTs. This doping is best realized when the doping chemical species is ordered itself within the carbon network and/or is contained within the CNTs themselves.

Multiple types of macro-scale CNT fiber production exist, such as 1) direct extraction of fibers from the aerogel of a floating catalyst chemical vapor deposition (FC-CVD) reactor; 2) dry spinning twisted CNT yarn from a CNT forest grown by plasma or thermal CVD; 3) solution spinning from acid-based CNT solutions, as outlined in the paragraph below.

The inclusion of fullerenes crystals, known as “nanopeapods” when inside the CNT or “nanobuds” when attached to the surface of the CNT, functionalize the CNTs to enhance performance in devices. More particularly, the encapsulation of fullerenes, such as C₆₀ inside carbon nanotubes creates a hybrid structure with enhanced properties. This configuration can be particularly beneficial for nanotechnology. The intermolecular charge transfer from the CNT to the fullerene improves overall performance. For example, encapsulated fullerenes act as electron acceptors, altering the electronic band structure of the hosting single-walled carbon nanotube (SWCNT). For example, one-dimensional, tunable, nano-scaled, superconducting electronic components, are usable in as transistors, diodes, and memory devices. Fullerenes filled inside CNTs function as metal-free, multifunctional electrocatalysts. Encapsulation within the robust walls of a carbon nanotube protects fragile fullerene crystals, resulting in stable, resilient structures capable of withstanding high-energy electron beams. Fullerenes inside nanotubes can be used as vehicles for transporting active molecules to targeted sites in biological systems. Fullerenes act as “corking” agents for open-ended nanotubes filled with other substances, preventing the release of the encapsulated payloads during cleaning and purification and aiding in the controlled release of inorganics.

Production methods to produce nanotubes in less than macroscale quantities include arc discharge, laser ablation and high pressure carbon monoxide (HiPco). These processes take place in vacuum or at low pressure with process gases. Higher yield and purity of SWNTs may be prepared by a dual-pulsed laser. But all of these processes require high energy inputs. A chemical catalysis method was uses a hydrocarbon feedstock is used in combination with a metal catalyst. The catalyst is typically, but not limited to iron, cobalt, or iron/molybdenum and heated under reducing conditions in the presence of a suitable carbon feedstock, e.g., ethylene. But this method has not been found suitable for scale-up.

Acid treatment of CNTs is a well-known process used to purify, functionalize, and disperse them by removing amorphous carbon and introducing oxygen-containing groups (e.g., carboxylic acid). While strong acids, such as nitric or sulfuric acid, are common, they can cause structural damage; alternative methods use mild acids or specialized solvent systems for improved dispersion in composites and electronic applications. Common functionalization processes often require refluxing in nitric acid (HNO₃), chlorosulfonic acid, sulfuric acid (H₂SO₄), carboxylic acid or hydrochloric acid (HCl), resulting in poor control while adding safety, cost, and environmental burdens. Furthermore, many of these acids are superacids, having a pH less than 1 and are hazardous for handling and use.

Particularly, superacids have environmental and logistical complexities and are expensive to handle. Superacids protonate species, such as CNTs and C60, that would otherwise act as neutral or even acidic species in water or aprotic media. Furthermore super-acids degrade the fullerene molecules and hinder emergent quantum properties

Accordingly, it is an object of this invention to provide a method for incorporating fullerene crystals into CNTs, more particularly it is an object of this invention to provide such a method that is feasible without the use of acid, without the use of esoteric materials, without requiring excessive energy input and without methods that cannot be effectively scaled up. The method of the present invention advantageously does not require the use of super-acids, conserving cost and decreasing safety risks.

### SUMMARY OF THE INVENTION

In one embodiment the invention comprises a non-acidic fullerene solution with macroscopic, free-standing and self-supporting carbon nanotube materials. The carbon nanotube molecules and their larger agglomerations are predominantly adjacent and held together by van der Waals forces. The adjacent carbon nanotube molecules and carbon nanotube bundles are predominantly mutually aligned, providing relatively long empty channels.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a scale fragmentary perspective view of an illustrative carbon nanotube according to the prior art.

FIG. 1B is a scale side elevational view of three illustrative carbon nanotubes according to the prior art having indeterminate length.

FIG. 2A is a schematic elevational view of a carbon nanotube in a heated bath according to a process of the present invention, shown partially in cutaway.

FIG. 2B is a table of exemplary solvent dielectric constants taken from the American Chemical Society, Division of Organic Chemistry.

FIG. 2C is a table of solvent Hansen dispersion factors.

FIG. 3A is a log-log graphical relationship of the Fullerene Long Range Order Measurement as a function of weight change.

FIG. 3B is a linear graphical relationship of the Fullerene Long Range Order Measurement as a function of weight change.

FIG. 4A is a wide angle X-ray of a CNT fiber according to the present invention with oriented fullerene supermolecule crystals.

FIG. 4B is a wide angle X-ray of a CNT fiber according to the present invention with unoriented fullerene supermolecule crystals.

FIG. 4C is a graphical relationship of wide angle X-ray peak percentage as a function of fullerene concentration.

FIG. 5A is a graphical relationship of the weight change of the carbon nanotube as a function of function of annealing or not annealing.

FIG. 5B is a graphical relationship of the weight change of the carbon nanotube as a function of fullerene concentration.

FIG. 5C is a graphical relationship of the mechanical strain to failure of the carbon nanotube as a function of wide angle X-ray scattering peak percentage.

FIG. 5D is a graphical relationship of the toughness to failure of the carbon nanotube as a function of wide angle X-ray scattering peak percentage.

FIG. 6A is a graphical relationship of the real [top graph] and imaginary [bottom graph] parts of the magnetic susceptibility as a function of temperature at a magnetic field strength of 0 Oersted and 20 Oersted.

FIG. 6B is a graphical relationship of the real [top graph] and imaginary [bottom graph] parts of the magnetic susceptibility as a function of temperature at a magnetic field strength of 1000 Oersted.

FIG. 6C is a graphical relationship of the real [top graph] and imaginary [bottom graph] parts of the magnetic susceptibility as a function of temperature at a magnetic field strength of 10000 Oersted.

### DETAILED DESCRIPTION OF THE INVENTION

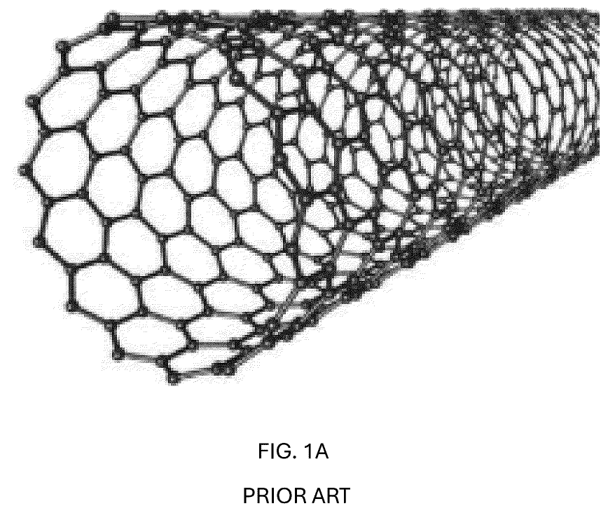

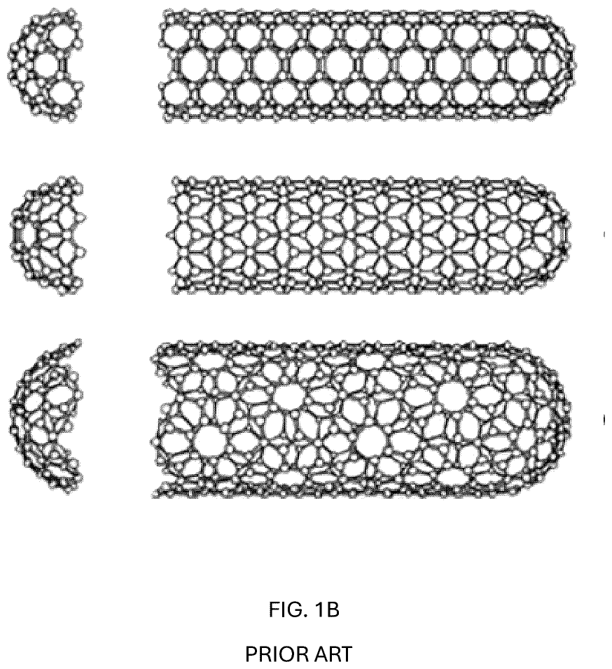

Referring to FIG. 1A and FIG. 1B, the present invention comprises a method of making hybrid carbon nanotubes (CNT) with fullerene supramolecular crystals and preferably oriented supermolecule crystals. The CNTs are assembled in aligned microstructures, so that channels between and/or within CNTs, form into an aligned network. Thus, as the fullerenes assemble into these channels, the fullerenes form an aligned network. The process of the present invention has been successfully demonstrated with fullerenes C60 and C70, although the invention is not so limited. Prophetically other suitable fullerene types include C20, C24, C26, C28, C30, C32, C34, C36, C38, C40, C60, C70, C72, C74, C76, C78, C80, C82, C84, C86, C88, C90, C92, C94, C96, endohedral fullerene crystals; functionalized fullerene crystals; polymerized fullerene crystals; nano-onion fullerene crystals and combination thereof.

An article according to the present invention may further comprise aligned carbon nanotubes with fullerene supramolecular crystals and/or amorphous agglomerations of fullerenes. In one aspect, said aligned carbon nanotubes may be in the form of bundles and may be single-wall carbon nanotubes, double wall carbon nanotubes, few walled carbon nanotubes, multi-walled carbon nanotubes, carbon nanotubes where the electronic species composition has been controlled, carbon nanotubes where the chirality has been controlled, ultrashort carbon nanotubes, small diameter carbon nanotubes, CNTs that are doped with foreign chemical species, and/or functionalized carbon nanotubes. Suitable precursor CNT fibers are available in ribbon form from DexMat of Houston, TX and sold under the name Galvorn®.

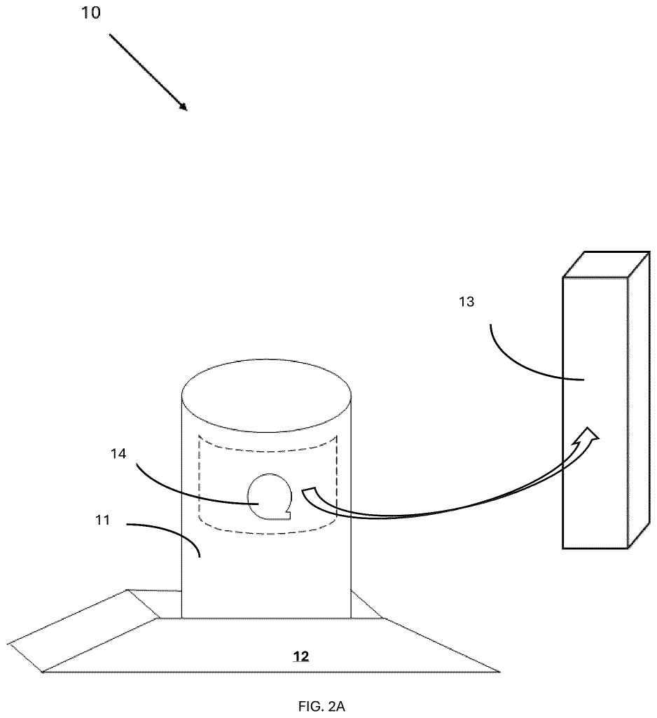

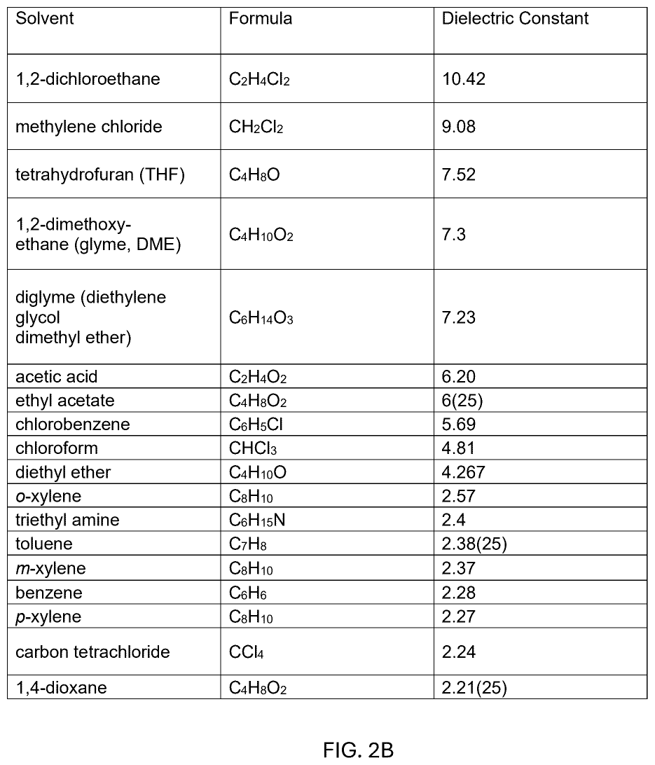

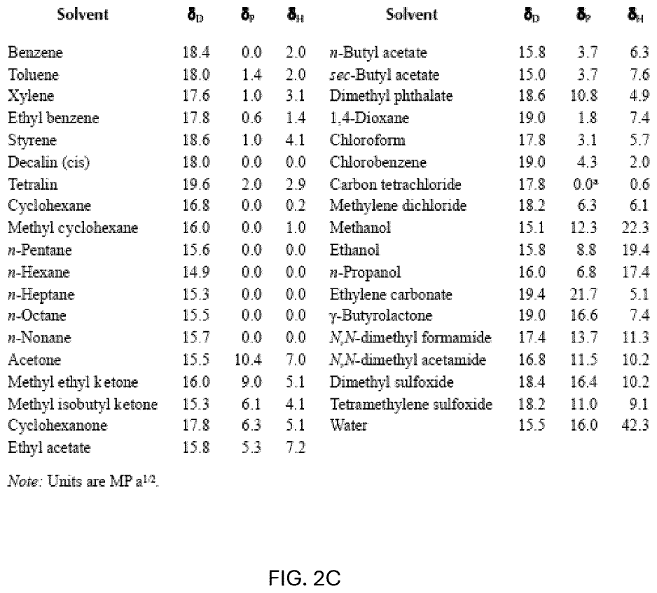

Referring to FIG. 2A, FIG. 2B and FIG. 2C, the fullerene solution has macroscopic, free-standing and self-supporting carbon nanotube materials. The carbon nanotube molecules and larger agglomerations, referred to as carbon nanotube bundles, are predominantly mutually adjacent and held together by van der Waals forces, as opposed being held together another substance or matrix. These adjacent carbon nanotube molecules and carbon nanotube bundles are predominantly mutually aligned with each other, e.g. within 30 degrees, and preferably within 5 degrees. This arrangement provides relatively long empty channels which are approximately the average length of the carbon nanotubes or greater, to provide for wicking of the fullerenes into the channels.

The precursor CNTs are bathed in a solution of fullerenes and selected for purposes of incorporating fullerene supramolecular crystals inside the CNT fiber. Applicants believe that the higher the solubility of the fullerene into the solvent, the greater the fullerene uptake into the CNT fiber will occur. This greater fullerene mass uptake into the fiber, causes larger fullerene crystal to be formed, leading to better fullerene crystal quality inside the CNT fibers.

Particulary 1-methylanhthalene C₁₁H₁₀ (1-MN) is preferred. Tetralin (1,2,3,4-tetrahydronaphthalene) C₁₀H₁₂ has also been successfully used, although its ability to dissolve C60 is believed to be less than that of 1-MN. Prophetically. 1-chloronaphthalene C₁₀H₇Cl and 1,2-dichlorobenzene C₆H₄Cl₂ are solvents which prophetically could work even better than 1-MN because due to likely dissolving a greater amount of fullerenes than 1-MN.

The process is preferably carried out at a temperature less than that which yields substantial solvent vapor, but which is high enough to increase the fullerene solubility limit and accordingly increase the fullerene mobility inside the fiber. The solvent bath 10 may occur at a temperature ranging from 20 C to 200 C with believe the best results being obtained at approximately 100 C. Solvents which dissolve C60 also have the benefit of having high evaporation temperatures.

The process may have a solvent bath 10 for a period of time sufficient for the solvent to wick into the CNT fibers and particularly into the interstitials thereof. Prophetically, a solvent bath 10 of at least 5 in, 10 seconds, 30 seconds or 60 seconds is sufficient to achieve wicking of the solvent into the CNTs. The solvent bath 10 may more particularly range from 1 day to 60 days, with less than 18 days being preferred and 3 to 9 days being more preferred. C60 concentrations in 1-MN may range from 0.003 to 0.07 mg/mL and more particularly from 0.005 to 0.043 mg/mL. A preferred trial was carried out with C60 in 1-MN at 0.045 mg/mL bathed for 3 days at 100 C. Another trial successfully bathed the CNTs in an open bath 10 at 200 C.

If the bath 10 is unheated, a sealed container 11 can hold the fullerene solution and CNT fibers as contents 14. If the bath 10 is heated, the container 11 is placed on a temperature controlled hotplate or other suitable heater 12. The container 11 is sealed to prevent evaporation.

After the bath 10, the CNTs are dried annealed to increase fullerene crystallinity. Drying occurs at temperatures less than below the evaporation temperature of the solvent. A temperature range of 75 C to 100 C has been found suitable. After drying the CNTs are held for an hour at 265 C, or otherwise slightly above the solvent evaporation temp, to drive off any remaining solvent.

Evaporation may be accomplished using a tube furnace 13 with an inert atmosphere. For example, the inert atmosphere may occur with a gas flow, particularly argon at 2.5 SLPM. Vacuum drying and immersing the CNTs into solvents which are incompatible with fullerenes, such as IPA and acetone, are feasible, but less preferred. Alternatively, the CNTs may be washed in tap water, decreasing the starting weight 20 to 30% by removing residuals native to the manufacturing process.

After drying, the resulting CNTs have interstitial fullerene supramolecular crystals. By interstitial it is meant that the fullerene supramolecular crystals are disposed within CNTs, between CNTs, and/or between CNT bundles, nominally with a preferred supramolecular crystal orientation with the fullerenes.

According to the present invention the solvent is a non-polar or weakly polar organic solvent. The solvent has a dielectric constant less than 10 and a Hansen dispersion parameter which is dominant over polar and hydrogen-bonding parameters. Solvents which have a Hansen dispersion factor from 2 to 10 are believed to be suitable.

The solvent may have a dielectric constant ranging from 2 to 10. Such a solvent is capable of dissolving fullerene species via non-reactive interactions dominated by dispersion forces and polarizability, with optional minor contributions from permanent dipole-dipole interactions. The solvent may be PH neutral, having a pH from 6.5 to 7.5.

Thus, for physical dissolution, the selected solvent for this process should be able to dissolve fullerenes where greater solubility leads to greater fullerene uptake. These selected solvents have the feature of being non-polar; because the fullerenes are non-polar. The selected solvents should likewise be aromatic or pi-bond rich; because the fullerenes are pi-bond rich. Preferably such solvent has a relatively large physical size relative to the fullerene and a high degree of polarizability. A partial incomplete list of selected solvents for physical dissolution, starting from most soluble to less soluble, include: 1-chloronaphthalene; 1-methylnaphthalene; 1,2-dichlorobenzene; 1,2,4-trimethylbenzene; carbon disulfide; 1,2,3-tribromopropane; chlorobenzene; p-xylene; bromoform; cumene; toluene; benzene; carbon tetrachloride, carbon disulfide, dimethyl sulfide, dimethyl sulfoxide and dimethyl sulfide. The typical use case is 1-methylnaphthalene because of low relative toxicity and high degree of solubility.

Beyond physical solubility discussed above, chemical dissolution may also dissolve fullerenes after a charge transfer to them, which is similarly useful for our process. This charge transfer to the fullerenes enables such fullerenes to interact with polar solvents and therefore dissolve. Strong acids for example, such as chlorosuphonic acid (CSA), can protonate fullerenes causing them to charge and then dissolve in the CSA. Similarly, oxidation reactions with fullerenes, such as with the Lewis Acid antimony pentafluoride, can cause them to dissolve in polar solvents. Functionalization of the fullerenes can also induce new intermolecular forces and also aid in dissolution. In these cases of chemical dissolution, they often are accompanied by damage to the fullerene molecule, which is typically at odds of superconductivity and other advanced electronic transport phenomena. For these reasons, physical dissolution is preferred but not absolutely necessary.

An important criterion for both chemical and physical dissolution in the solvent is the solubility of the fullerenes into the solvent. The solubility limit can be increased by thermodynamic parameters such as temperature, although temperature has a practical limit as evaporation and chemical modification becomes a constraint. Advantageously, using different combinations of selected solvents, and adding different chemicals to the solution not necessarily related to the solubility, does not alter the fundamental requirement that the fullerenes must dissolve in the solvent.

A suitable solvent is a derivative of naphthalene (C₁₀H₈). Naphthalene derivatives are functionalized compounds (e.g., naphthols, naphthylamines, nitro-, chloro-, and bromo-naphthalenes) derived from the C₁₀H₈ structure. Types of Naphthalene derivatives include: 1-Nitronaphthalene (C₁₀H₇NO₂); Napthols (C₁₀H₇OH); Naphthylamines (C₁₀H₇NH₂) and Naphthalenecarboxylic acids. The solvent may be non-aqueous. The nonaqueous solvent provides benefits of a broader range of reaction conditions and typically lower energy usage in industrial processes.

In one embodiment the solvent usable with the present invention has a Hamett acidity function greater than −12, and will not protonate CNTs or fullerenes. The a Hamett acidity function used to extend the measure of Brønsted-Lowry acidity beyond the dilute aqueous solutions for which the pH scale is useful. The Hammett acidity function, H₀, is defined as:

$${H}_{0} = - log {h}_{0} = - log ( {a}_{{H}_{3} {O}^{+}} \frac{{γ}_{B}}{{γ}_{{BH}^{+}}} ) = {pK}_{{BH}^{+}} + log \frac{[ B ]}{[ {BH}^{+} ]}$$

where a is the activity, and γ are the thermodynamic activity coefficients of a base B and its conjugate acid BH⁺ and pK_{BH}⁺ is-log (K) for the dissociation of BH⁺. As a benchmark, H₂SO₄ has a Hamett acidity function of 12 and is excluded from the present invention. Likewise, chlorosulphonic acid has a Hamett acidity function of −13.79, protonates CNT and fullerenes and is excluded from the present invention. Conversely, trifluoracetic acid has a Hamett acidity function of −2.7 and nitic acid has a Hamett acidity function −6.3, and are within the scope of the present invention.

The solvent of the present invention may have a Hamett acidity function of −12 to 12, preferably—12 to 5, more preferably −5 to 2 and still more preferably −2 to 1. Thus superacids and the associated cost and hazards are completely avoided. Furthermore the solvent according to the present invention beneficially approaches neutral acidity.

In dilute aqueous solutions H₀ is almost equal to the pH, making an H₀ of 0 equivalent to a pH of 0. As the H₀ approaches 0, or subsists in a range more closely approximating 0, the benefits of the invention increase. Handling of neutral solvents and the attendant solvent bath 10, avoids the hazards and costs of both acidic and caustic solvents. Thus, as the range of the Hamett acidity function narrows closer to 0, the benefits of the invention increase.

Referring particularly to FIG. 2C, the Hansen dispersion factors are taken from Charles Hansen, Hansen Solubility Parameters, A User's Handbook, CRC Press, second edition, incorporated herein by reference where δ_{D} is the Dispersion cohesion (solubility) parameter, δ_{H} is the Hydrogen bonding cohesion (solubility) parameter and δ_{P} Polar cohesion (solubility) parameter, incorporated herein. The solvent may have Hansen solubility parameters characterized by a dispersion component δ_{D} greater than each of the polar components δ_{P} and hydrogen-bonding component δ_{H}, preferably with δ_{D}>2 δ_{P} and δ_{D}>2 δ_{H}. According to the present invention, δ_{D} may be from about 17 to 22 MPa^{1/2} and δ_{P} from about 0 to 8 MPa^{1/2} and δ_{H} from about 0 to 8 MPa^{1/2}, and preferably δ_{D} may be from about 18 to 21 MPa^{1/2} and δ_{P} from about 0 to 6 MPa_{1/2} and δ_{H} from about 0 to 6 MPa^{1/2}, and more preferably δ_{D} may be from about 19 to 21 MPa^{1/2} and δ_{P} less than about 4 MPa^{1/2} and δ_{H} less than about 4 MPa^{1/2}.

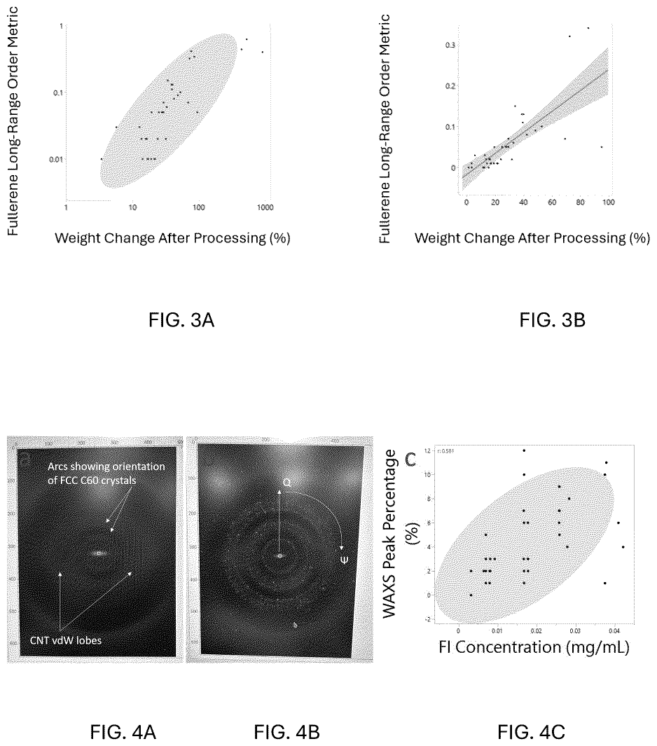

Referring to FIG. 3A and FIG. 3B, for C60 the presence of structurally intact and chemically unmodified C60 can be confirmed by 13C NMR spectroscopy. Particularly, a single narrow resonance peak at approximately 143 ppm indicates significant broadening, splitting, lack of symmetry and/or damage to the cage.

Solid state 13C NMR spectroscopy exhibits one or more discrete, narrow full width at half maximum resonances of 5 ppm, corresponding to symmetry defined aspects of the various fullerene molecules. The number and position of these resonances are consistent with known fullerene structures.

The Fullerene Long-Range Order Metric is a quantitative measure used to assess the degree of periodic long-range ordering of fullerene supramolecular assemblies within a carbon nanotube material with aligned CNTs. Advantageously, this method does not require explicit crystallinity determination through detailed peak fitting procedures. This metric enables comparison of samples by isolating the fullerene-derived scattering contribution from the CNT background. It is expected that higher values of this metric correspond to fullerene arrangements that are more favorable for advanced electrical conduction phenomena, including superconductivity.

This metric is obtained using wide-angle X-ray scattering (WAXS). Transmission WAXS measurements are performed using a Xenocs Xeuss 3.0 instrument with a Cu Kα wavelength of 1.5406 Å and a Pilatus 300K detector. Measurements are conducted in line eraser mode with an exposure time of 10,800 s per exposure. Line eraser mode reduces horizontal detector artifacts associated with detector readout. A sample-detector distance of approximately 55 mm is used under the standard instrument configuration.

Following data acquisition, post-processing is performed to isolate the fullerene scattering contribution. An orientation-selective azimuthal mask is applied to exclude scattering intensity associated with the aligned CNT phase. Because the apparent azimuthal position of anisotropic scattering features depends on the orientation of the CNT material relative to the detector, the masking operation is defined in a coordinate system referenced to the CNT material axis rather than fixed detector angles. The CNT material axis is defined as the azimuthal direction corresponding to the principal alignment direction of the CNTs (e.g., 0° and) 180°.

The masking window is selected to exclude azimuthal regions corresponding to the dominant anisotropic CNT scattering while retaining regions containing predominantly isotropic or oriented fullerene scattering. The mask includes an angular range of approximately 35° to 145° relative to the CNT material axis and includes scattering vector values in the range of approximately 0.3 to 2.7 Å⁻¹. Data outside the selected angular and q ranges are excluded from further analysis.

The remaining intensity is azimuthally averaged to yield intensity as a function of scattering vector, q, in units of Å⁻¹. The resulting intensity profile comprises a broad background contribution associated with disordered or amorphous components, with superimposed peaks corresponding to periodic intermolecular spacing of fullerene assemblies.

The total integrated intensity over the selected q-range is computed to yield a value A. A background contribution is then determined by fitting a smooth baseline to the intensity profile while excluding peak regions, using a polynomial fitting method, and integrating this background intensity over the selected q-range to yield a value B. This metric represents the fraction of scattering intensity attributable to periodic fullerene ordering relative to the total scattering intensity within the selected q-range.

The Fullerene Long-Range Order Metric is defined as:

$$\frac{A - B}{A} .$$

The Fullerene Long-Range Order Metric according to the present invention ranges between 0.05 and 1, more preferably between 0.1 and 1, and most preferably between 0.2 and 1. In extreme situations, a film of fullerenes on the surface of the CNTs, can have a weight gain greater than 100%. This weight gain can lead to a Fullerene Long-Range Order Metric greater than 0.8. By definition, the Fullerene Long-Range Order Metric can never be greater than 1.

It has been observed that concentrations greater than 0.01 g/mL, or weight increases greater than 25% have the increase in the Long-Range Order Metric with increases concentration or mass uptake. Fullerene orientation tends to diminish with increasing concentrations and mass uptake. But some fullerene orientation may still remain by concentrations of 0.03654 g/mL, i.e. weight increases greater than 40% from start and vanishes by 0.0469 g/mL, i.e. weight increases greater than 52%.

Referring to FIG. 4A, FIG. 4B and FIG. 4C, transmission wide angle x-ray diffraction (WAXS) using a Xeuss 3.0 wide angle X-ray scattering system instrument available from Xenocs SAS of Grenoble, France (Cu K_wavelength of 1.5406 A with a Pilatus 300 K detector) was used to examine the CNT fiber for oriented C60 supramolecular crystals and the characteristic pattern for aligned CNT fiber diffraction (lobes for aligned van der Waals spacing at 4 A and carbon-carbon ring at 2.2 A) superimposed with the oriented C60 fullerene diffraction pattern (a complementary “fiber-diffraction-like” pattern with hkl diffraction peaks from a uniaxial aligned unit cell).

A crystalline quality metric was defined as the area of the diffraction peaks (between Q=1 to 1.8 A-1 and 65 degrees to 115 degrees) minus an amorphous background, then divided by the amorphous background. The degree of fullerene supramolecular crystal orientation was estimated by the full width half maximum (FWHM) of these peaks over the azimuthal angle, whereas a FWHM of 180 degrees indicates no orientation. The amount of fullerene uptake was determined by Sartorius microbalance just before the fullerene bath 10 and after solvent removal.

The WAXS examples that were made through this process included a, CNT ribbon with oriented C60 supramolecular crystals and a CNT ribbon with unoriented C60 supramolecular crystals. It was discovered that the crystal quality metric is most affected by the fullerene bath 10 concentration (correlation 58%).

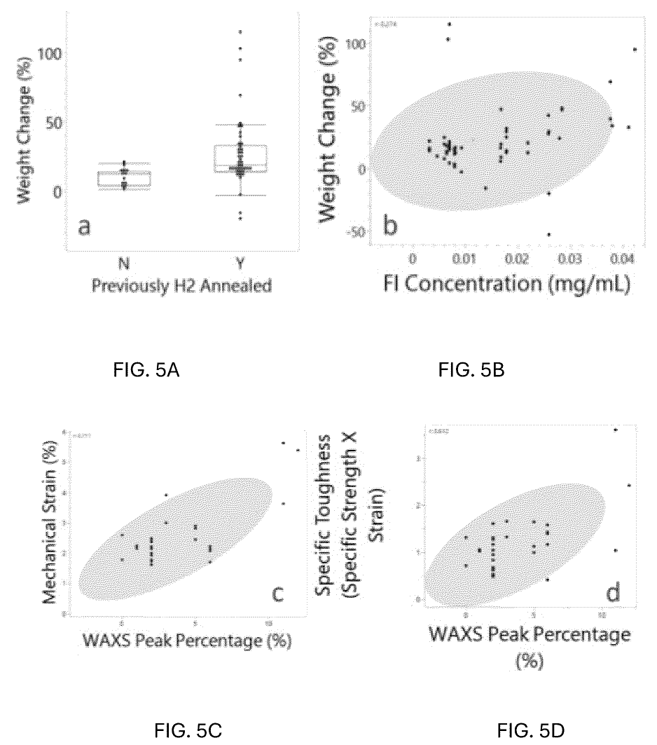

Referring to FIG. 5A, FIG. 5B, FIG. 5C and FIG. 5D, the most significant factor affecting fullerene incorporation, as shown by weight uptake, following the fullerene bath 10 and solvent removal was whether or not the sample was previously hydrogen annealed to remove residual acid dopants. Fullerene concentration was a milder though statistically significant factor (27% correlation). Standard four-probe resistance measurement from a multimeter and tensile strength from a tensile tester were used to measure specific conductivity and specific strength respectively.

The CNT C60 was baked with hybrid material under roughing pump vacuum for approximately 3 hours at 150 C to remove physio absorbed air and water species. The CNT C60 hybrid (under vacuum) was transferred to the glovebox and combined with potassium (physically touching) in a quartz vessel. This quartz vessel was sealed (under vacuum) and transferred to a box oven set to 300 C for 2 days. The sealed sample was opened back in the glovebox and transferred to a Quantum Design Physical Properties Measurement System (PPMS) with ACMS option that yields AC susceptibility X (with real and imaginary components) as a function of temperature and applied magnetic field.

FIGS. 5C and 5D particularly show that better fullerene crystalline quality increases the CNT mechanical strain-to-failure and specific toughness, with correlations of 72% and 61%, respectively. The CNT fiber infiltrated with C60 supramolecular crystals manufactured through the process of the present invention can be made to have superconducting properties by doping with alkali metals. Superconducting properties were accomplished with established procedures used for powders or non-self-supporting films of fullerenes, where the CNT C60 hybrid material (60 mg) was combined and heated with potassium (10 mg) in accepted stoichiometric ratios (K3C60) and care is taken to avoid atmosphere exposure.

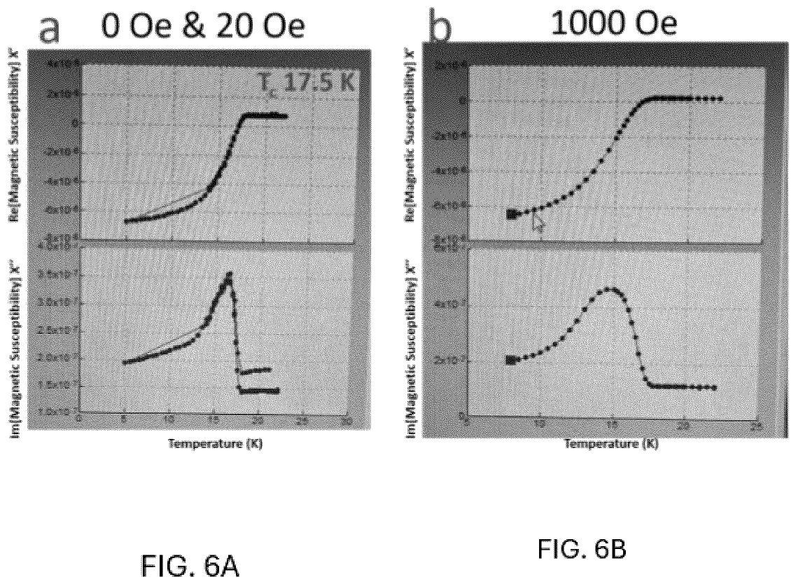

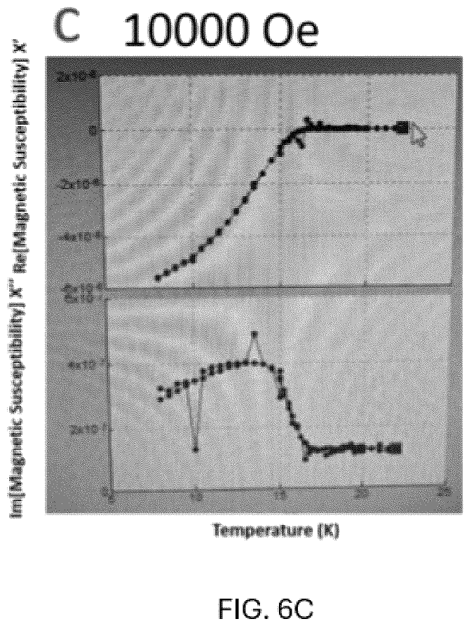

Referring to FIG. 6A, FIG. 6B and FIG. 6C, the K doped CNT C60 hybrid shows the real (top) and imaginary (bottom) AC susceptibility as a function of temperature for 4 DC fields: 0 Oersted (Oe), 20 Oe, 1000 Oe, 10000 Oe. A superconducting transition temperature Tc is shown at 17.5 K, with magnetic field slightly suppressing the overall signal and lowering Tc. In all magnetic field cases, the temperature sweep-up (zero field cooling) and temperature sweepdown (field cooling) closely match Hc1 in most cases, implying this sweep-up/sweep-down overlap shows that flux pinning is weak.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A method of making hybrid carbon nanotube bundles, the method comprising the steps of:
disposing at least one precursor carbon nanotube bundle having aligned carbon nanotubes into a PH neutral bath having a solvent derivative of naphthalene with fullerene crystals at a temperature of 20 C to 200 C for a period of time sufficient for the solvent to wick into the carbon nanotube bundle to thereby retain fullerenes in and/or among the carbon nanotubes;
removing the at least one carbon nanotube bundle having a plurality of retained fullerene crystals; and
drying the at least one carbon nanotube bundle having the retained fullerene crystals.

2. The method according to claim 1 wherein the solvent is selected from the group consisting of: Napthols (C₁₀H₇OH); Naphthylamines (C₁₀H₇NH₂); and combinations thereof.

3. The method according to claim 1 wherein the solvent is selected from the group consisting of: 1-methylanhthalene; 1,2,3,4-tetrahydronaphthalene; 1-chloronap; 1,2-dichlorobenzene and combinations thereof.

4. The method according to claim 1 wherein the solvent is selected from the group consisting of: aromatic hydrocarbons; halogenated organic solvents and sulfur containing organic solvents.

5. The method of claim 2 wherein the fullerene crystal is selected from the group consisting of C20; C24; C26; C28; C30; C32; C34; C36; C38; C40; C60; C70; C72; C74; C76; C78; C80; C82; C84; C86; C88; C90; C92; C94; C96 and combinations thereof.

6. The method of claim 5 wherein the fullerene crystal is selected from the group consisting of C60 and C70.

7. The method of claim 6 wherein the fullerene crystal is C60.

8. The method according to claim 1 wherein the step of drying the at least one carbon nanotube bundle having the fullerene crystals comprises the step of drying at a temperature of 20 C to 200 C.

9. The method according to claim 8 wherein the step of drying the carbon nanotube occurs in an inert atmosphere.

10. The method according to claim 9 wherein the inert atmosphere is argon.

11. The method according to claim 1 wherein the solvent has a concentration of 0.003 to 0.07 mg/mL.

12. The method according to claim 10 wherein the solvent has a concentration of 0.005 to 0.043 mg/mL.

13. A method of making hybrid carbon nanotube bundles, the method comprising the steps of:
disposing at least one precursor carbon nanotube bundle having aligned carbon nanotubes into a PH neutral bath having a solvent with fullerene crystals and selected from the group consisting of aromatic organic hydrocarbons, halogenated organic solvents and combinations thereof with fullerene crystals at a temperature of 20 C to 200 C for a period of time sufficient for the solvent to wick into the carbon nanotube bundle to thereby retain a plurality of fullerene crystals in and/or among the carbon nanotubes;
removing the at least one carbon nanotube bundle having the retained fullerene crystals; and
drying the at least one carbon nanotube bundle having the retained fullerene crystals.

14. The method according to claim 13 wherein the solvent is selected from the group consisting of 1-chloronaphthalene; 1-methylnaphthalene; 1,2-dichlorobenzene; 1,2,4-trimethylbenzene; 1,2,3-tribromopropane; chlorobenzene; p-xylene; bromoform; cumene; toluene; benzene; carbon tetrachloride and combinations thereof.

15. The method according to claim 14 wherein the fullerene crystals are selected from the group consisting of endohedral fullerene crystals; functionalized fullerene crystals; polymerized fullerene crystals; nano-onion fullerene crystals and combination thereof.

16. A method of making hybrid carbon nanotube bundles, the method comprising the steps of:
disposing at least one precursor carbon nanotube bundle having aligned carbon nanotubes into a pH neutral bath having a solvent at a temperature of 20 C to 200 C and comprising an organosulfer compound with fullerene crystals for a period of 60 seconds to 60 days to thereby retain fullerene crystals in and/or among the carbon nanotubes;
removing the at least one carbon nanotube bundle having the retained fullerene crystals; and
drying the at least one carbon nanotube bundle having the retained fullerene crystals.

17. The method according to claim 16 wherein the organosulfer compound is selected from the group consisting of carbon disulfide, dimethyl sulfide, dimethyl sulfoxide and dimethyl sulfide.

18. The method according to claim 17 wherein the step of drying the at least one carbon nanotube bundle having the fullerene crystals comprises the step of drying in an inert atmosphere.

19. The method according to claim 18 wherein the fullerene crystals are selected from the group consisting of endohedral fullerene crystals; functionalized fullerene crystals; polymerized fullerene crystals; nano-onion fullerene crystals and combinations thereof.

20. The method according to claim 13 wherein the solvent bath has Hamett acidity function greater ranging from −12 to 5.
